(19) United States
(12) Patent Application Publication
(10) Pub. No.: US 2011/0141952 A1
(43) Pub. Date: Jun. 16, 2011

(54) METHOD AND APPARATUS FOR PROVIDING BUNDLED TRANSMISSIONS

(75) Inventors: Hai Ming Wang, Beijing (CN); Jing Han, Beijing (CN)

(73) Assignee: NOKIA CORPORATION, Espoo (FI)

(21) Appl. No.: 13/058,774

(22) PCT Filed: Aug. 10, 2009
(86) PCT No.: PCT/IB09/06493

§ 371 Date: Feb. 11, 2011

Related U.S. Application Data
(60) Provisional application No. 61/087,878, filed on Aug. 11, 2008.

(51) Int. Cl. H04L 5/14

(52) U.S. Cl. 370/294

(57) ABSTRACT

An approach for providing bundled transmission is disclosed. A logic allocates a plurality of transmission time intervals (TTIs) of a time duplex division (TDD) transmission scheme as a bundle for supporting transmission of duplicate data over the TTIs. The bundle of TTIs is associated with a plurality of initial hybrid automatic repeat request (HARQ) processes. The logic also maintains one or more of the same initial HARQ processes as unbundled for a predetermined TDD configuration.

### RELATED APPLICATIONS

This application claims the benefit of the earlier filing date under 35 U.S.C. §119(e) of U.S. Provisional Application Ser. No. 61/087,878 filed Aug. 11, 2008, entitled “Method and Apparatus for Providing Bundled Transmissions,” the entirety of which is incorporated herein by reference.

### FIELD OF INVENTION

The exemplary and non-limiting embodiments of this invention relate generally to a method and apparatus for providing bundled transmissions.

### BACKGROUND

Radio communication systems, such as a wireless data networks (e.g., Third Generation Partnership Project (3GPP) Long Term Evolution (LTE) systems, spread spectrum systems (such as Code Division Multiple Access (CDMA) networks), Time Division Multiple Access (TDMA) networks, WiMAX (Worldwide Interoperability for Microwave Access), etc.), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One area of effort involves acknowledgment signaling, whereby transmissions can be implicitly or explicitly acknowledged to convey successful transmission of data. An inefficient acknowledgement scheme can unnecessarily consume network resources. Moreover, the process of resource allocation for supporting such acknowledgement can result in resource collisions under certain circumstances.

Therefore, there is a need for an approach for providing efficient signaling, which can co-exist with already developed standards and protocols.

### SOME EXAMPLE EMBODIMENTS

According to one embodiment, a method comprises allocating a plurality of transmission time intervals (TTIs) of a time duplex division (TDD) transmission scheme as a bundle for supporting transmission of duplicate data over the TTIs. The bundle of TTIs is associated with a plurality of initial hybrid automatic repeat request (HARQ) processes. The method also comprises maintaining one or more of the same initial HARQ processes as unbundled for a predetermined TDD configuration.

According to another embodiment, a computer-readable medium carries one or more sequences of one or more instructions which, when executed by one or more processors, cause an apparatus to allocate a plurality of transmission time intervals (TTIs) of a time duplex division (TDD) transmission scheme as a bundle for supporting transmission of duplicate data over the TTIs. The bundle of TTIs is associated with a plurality of initial hybrid automatic repeat request (HARQ) processes. The apparatus is also caused to maintain one or more of the same initial HARQ processes as unbundled for a predetermined TDD configuration.

According to another embodiment, an apparatus comprises a logic configured to allocate a plurality of transmission time intervals (TTIs) of a time duplex division (TDD) transmission scheme as a bundle for supporting transmission of duplicate data over the TTIs. The bundle of TTIs is associated with a plurality of initial hybrid automatic repeat request (HARQ) processes. The logic is also configured to maintain one or more of the same initial HARQ processes as unbundled for a predetermined TDD configuration.

According to another embodiment, an apparatus comprises means for allocating a plurality of transmission time intervals (TTIs) of a time duplex division (TDD) transmission scheme as a bundle for supporting transmission of duplicate data over the TTIs. The bundle of TTIs is associated with a plurality of initial hybrid automatic repeat request (HARQ) processes. The apparatus also comprises means for maintaining one or more of the same initial HARQ processes as unbundled for a predetermined TDD configuration.

According to another embodiment, a method comprises determining whether any real transmissions are utilized in a plurality of transmission time intervals (TTIs) of a time duplex division (TDD) transmission scheme. The plurality of TTIs is allocated as a bundle and the bundle of TTIs overlap with a measurement gap period. The method also comprises interpreting an acknowledgement signal corresponding to a last subframe of the bundle of TTIs if there are any real transmissions utilized in the bundle of TTIs. The method further comprises ignoring the acknowledgement signal if there are no real transmissions utilized in the bundle of TTIs.

According to another embodiment, a computer-readable medium carries one or more sequences of one or more instructions which, when executed by one or more processors, cause an apparatus to determine whether any real transmissions are utilized in a plurality of transmission time intervals (TTIs) of a time duplex division (TDD) transmission scheme. The plurality of TTIs is allocated as a bundle and the bundle of TTIs overlap with a measurement gap period. The apparatus is also caused to interpret an acknowledgement signal corresponding to a last subframe of the bundle of TTIs if there are any real transmissions utilized in the bundle of TTIs. The apparatus is further caused to ignore the acknowledgement signal if there are no real transmissions utilized in the bundle of TTIs.

According to another embodiment, an apparatus comprises a logic configured to determine whether any real transmissions are utilized in a plurality of transmission time intervals (TTIs) of a time duplex division (TDD) transmission scheme. The plurality of TTIs is allocated as a bundle and the bundle of TTIs overlap with a measurement gap period. The logic is also configured to interpret an acknowledgement signal corresponding to a last subframe of the bundle of TTIs if there are any real transmissions utilized in the bundle of TTIs. The logic is further configured to ignore the acknowledgement signal if there are no real transmissions utilized in the bundle of TTIs.

According to yet another embodiment, an apparatus comprises means for determining whether any real transmissions are utilized in a plurality of transmission time intervals (TTIs) of a time duplex division (TDD) transmission scheme. The plurality of TTIs is allocated as a bundle and the bundle of TTIs overlap with a measurement gap period. The apparatus also comprises means for interpreting an acknowledgement signal corresponding to a last subframe of the bundle of TTIs if there are any real transmissions utilized in the bundle of TTIs. The apparatus further comprises means for ignoring the acknowledgement signal if there are no real transmissions utilized in the bundle of TTIs.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communication system capable of providing acknowledgement bundling, according to an exemplary embodiment;

FIG. 2 is a flowchart of a process for transmitting information using bundled transmission time intervals (TTIs), according to an exemplary embodiment;

FIG. 3 is a flowchart of a process for providing TTI bundling as to avoid resource collisions, according to an exemplary embodiment;

FIG. 4 is a diagram of an exemplary transmission process for a frequency division duplex (FDD) scheme involving TTI bundling combined with a hybrid automatic repeat request (HARQ) mechanism, according to an exemplary embodiment;

FIGS. 5A-5D are diagrams of exemplary time division duplex (TDD) configurations implementing a HARQ process, according to various embodiments;

FIG. 6 is a diagram of a transmission process that avoids resource collisions using TTI bundling combined with a HARQ mechanism for TDD configuration 0, according to an exemplary embodiment;

FIG. 7 is a flowchart of a process for handling an overlap condition between a measurement gap and a TTI bundle, according to an exemplary embodiment;

FIG. 8 is a diagram of a scenario involving an interaction between a measurement gap and TTI bundling, according to an exemplary embodiment;

FIGS. 9A-9C are diagrams of exemplary TDD configurations involving the interaction between a measurement gap and TTI bundling, according to various exemplary embodiments;

FIGS. 10A-10D are diagrams of communication systems having exemplary long-term evolution (LTE) and E-UTRA (Evolved Universal Terrestrial Radio Access) architectures, in which the system of FIG. 1 can operate to provide resource allocation, according to various exemplary embodiments of the invention;

FIG. 11 is a diagram of hardware that can be used to implement an embodiment of the invention; and

FIG. 12 is a diagram of exemplary components of a user terminal configured to operate in the systems of FIGS. 10A-10D, according to an embodiment of the invention.

### DESCRIPTION OF SOME EMBODIMENTS

An apparatus, method, and software for transmission bundling are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a wireless network compliant with the Third Generation Partnership Project (3GPP) Long Term Evolution (LTE) architecture, it is recognized by one of ordinary skill in the art that the embodiments of the inventions have applicability to any type of communication system and equivalent functional capabilities.

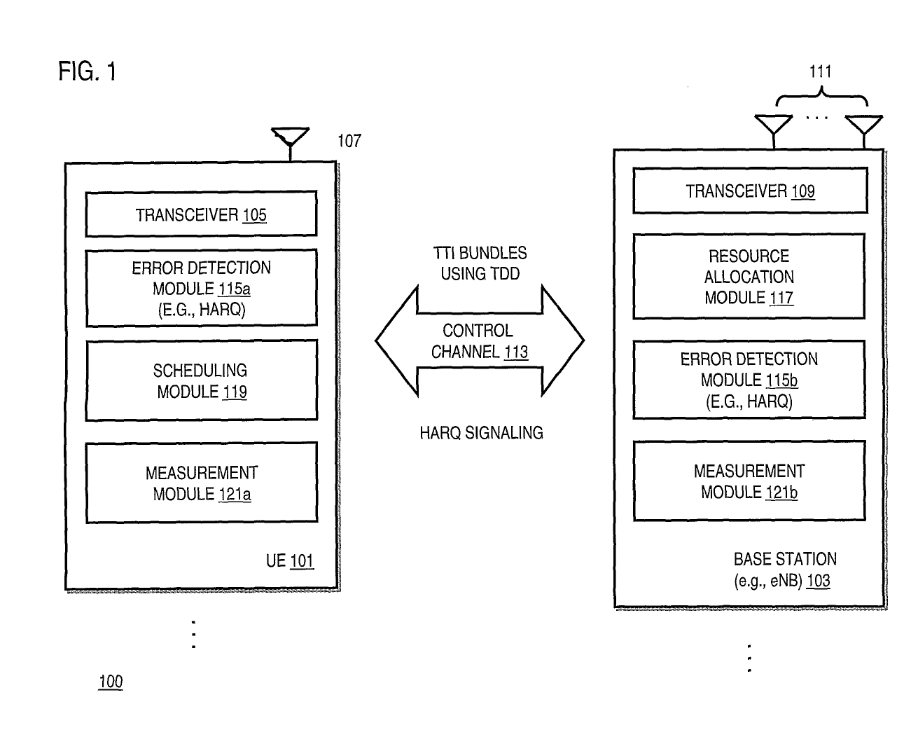

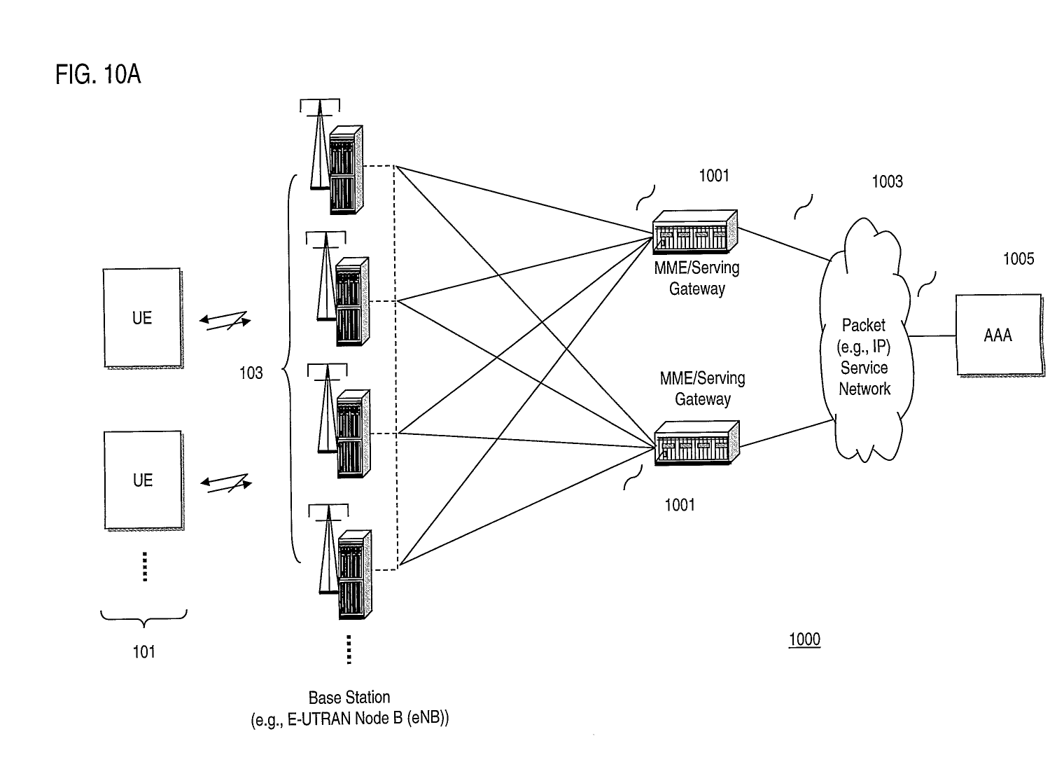

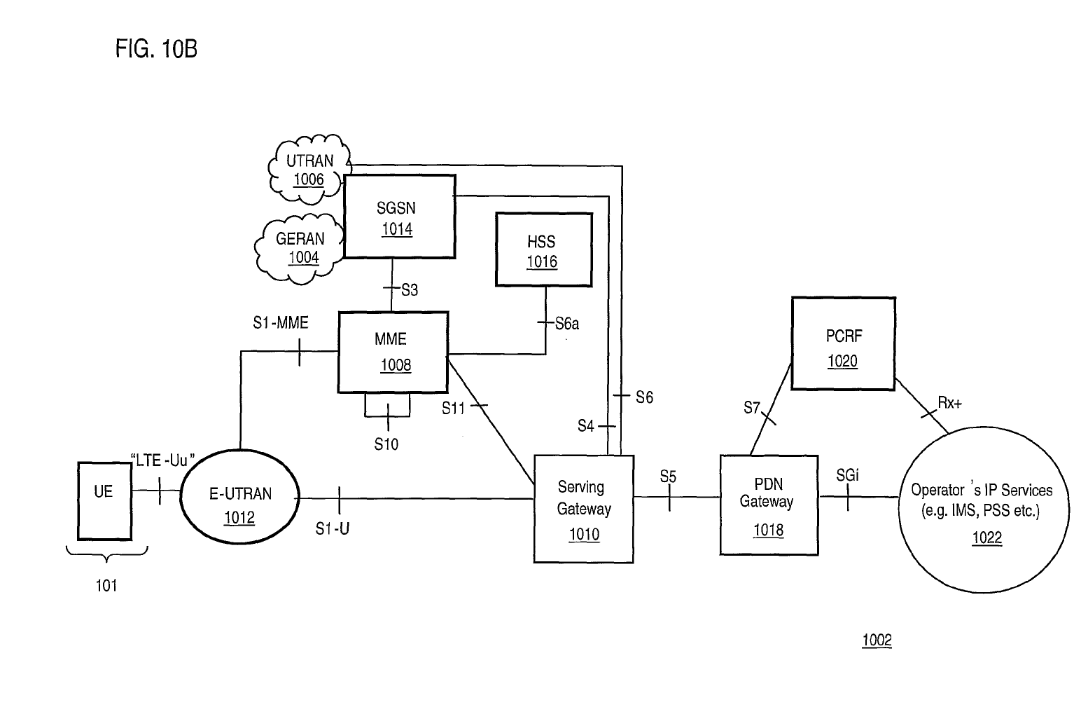

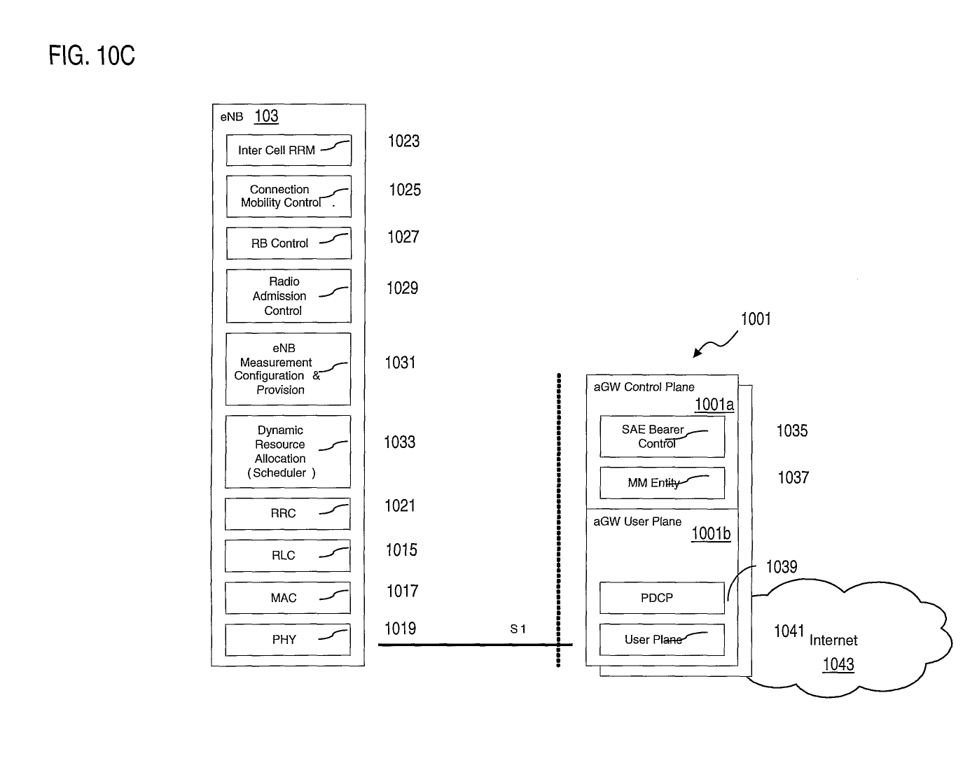

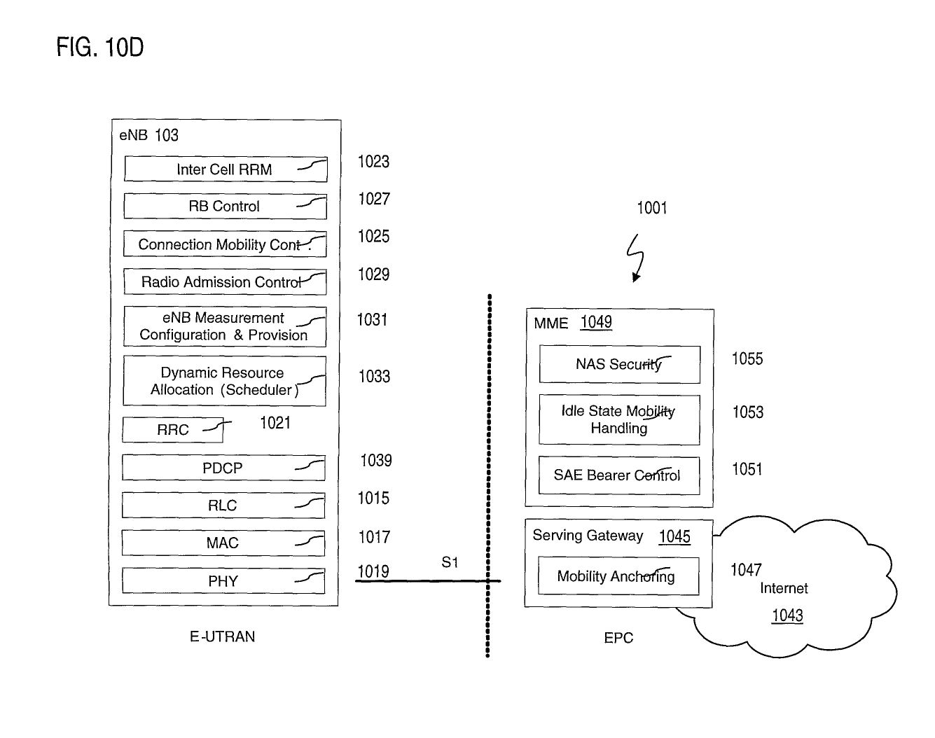

FIG. 1 is a diagram of a communication system capable of providing acknowledgement bundling, according to an exemplary embodiment. As shown in FIG. 1, one or more user equipment (UEs) 101 communicate with a base station 103, which is part of an access network (e.g., 3GPP LTE or E-UTRAN, etc.). Under the 3GPP LTE architecture (as shown in FIGS. 10A-10D), the base station 103 is denoted as an enhanced Node B (eNB). The UE 101 can be any type of mobile stations, such as handsets, terminals, stations, units, devices, multimedia tablets, Internet nodes, communicators, Personal Digital Assistants (PDAs) or any type of interface to the user (such as “wearable” circuitry, etc.). The UE 101 includes a transceiver 105 and an antenna system 107 that couples to the transceiver 105 to receive or transmit signals from the base station 103. The antenna system 107 can include one or more antennas. For the purposes of illustration, the time division duplex (TDD) mode of 3GPP is described herein; however, it is recognized that other modes can be supported, e.g., frequency division duplex (FDD).

As with the UE 101, the base station 103 employs a transceiver 109, which transmits information to the UE 101. Also, the base station 103 can employ one or more antennas for transmitting and receiving electromagnetic signals. For instance, the Node B 103 may utilize a Multiple Input Multiple Output (MIMO) antenna system 111, whereby the Node B 103 can support multiple antenna transmit and receive capabilities. This arrangement can support the parallel transmission of independent data streams to achieve high data rates between the UE 101 and Node B 103. The base station 103, in an exemplary embodiment, uses OFDM (Orthogonal Frequency Divisional Multiplexing) as a downlink (DL) transmission scheme and a single-carrier transmission (e.g., SC-FDMA (Single Carrier-Frequency Division Multiple Access) with cyclic prefix for the uplink (UL) transmission scheme. SC-FDMA can also be realized using a DFT-S-OFDM principle, which is detailed in 3GGP TR 25.814, entitled “Physical Layer Aspects for Evolved UTRA,” v.1.5.0, May 2006 (which is incorporated herein by reference in its entirety). SC-FDMA, also referred to as Multi-User-SC-FDMA, allows multiple users to transmit simultaneously on different sub-bands.

Communications between the UE 101 and the base station 103 (and thus, the network) is governed, in part, by control information exchanged between the two entities. Such control information, in an exemplary embodiment, is transported over a control channel 113 on, for example, the downlink from the base station 103 to the UE 101.

To ensure accurate delivery of information between the eNB 103 and the UE 101, the system 100 utilizes error detection to exchange information, e.g., Hybrid ARQ (HARQ). HARQ is a concatenation of Forward Error Correction (FEC) coding and an Automatic Repeat Request (ARQ) protocol. Automatic Repeat Request (ARQ) is an error detection mechanism used on the link layer. As such, this error detection scheme, as well as other schemes (e.g., CRC (cyclic redundancy check)), can be performed by error detection modules 115a and 115b within the eNB 103 and UE 101, respectively. The HARQ mechanism permits the receiver (e.g., UE 101) to indicate to the transmitter (e.g., eNB 103) that a packet or sub-packet has been received incorrectly, and thus, requests the transmitter to resend the particular packet(s).

The base station 103 provides resource allocation module 117 (or logic) for allocating resources for a communication link with the UE 101. The communication link, in this example, involves the downlink, which supports traffic from the network to the user, as well as an uplink for transmission of data from the UE 101 to the BS 103. In the LTE, the BS 103 maintains tight control of the transmission resources. That is, the BS 103 will, in a controlled manner, provide resources for both uplink and downlink transmissions. Typically, these are given on (1) a time-by-time basis (one grant per transmission), or (2) as semi-persistent allocations/grants, where the resources are given for a longer time period. On the user (or subscriber) side, the UE 101 utilizes a scheduling module 119 (or logic) for scheduling transmission of information stored within a transmission buffer (not shown).

In this example, the allocated resources involve physical resource blocks (PRB), which correspond to OFDM symbols, to provide communication between the UE 101 and the eNB 103. That is, the OFDM symbols are organized into a number of PRBs that includes consecutive sub-carriers for corresponding consecutive OFDM symbols. To indicate which PRBs (or sub-carrier) are allocated to the UE 101, two exemplary schemes include: (1) bit mapping, and (2) (start, length) by using several bits indicating the start and the length of an allocation block. This signaling of the start and the length will typically use joint coding (i.e., they are signaled using one code word, which contains the information for both parts).

The system 100, according to certain embodiments, employs the TDD (Time domain duplex) mode of 3GPP. It is noted that scheduling over multiple subframes (e.g., multi-TTI (Transmission Time Interval)) can be provided, since the scheduling functionality already considers several subframes at the same time instance (as opposed to FDD where the scheduler only considers one subframe at a time). The possible gain mechanisms, according to an exemplary embodiment, include: (1) reduction of overhead for transmitting allocation information in downlink and ACK (Acknowledgement)/NACK (Negative-Acknowledgement) reports in the uplink; and (2) increased coverage gain in the uplink.

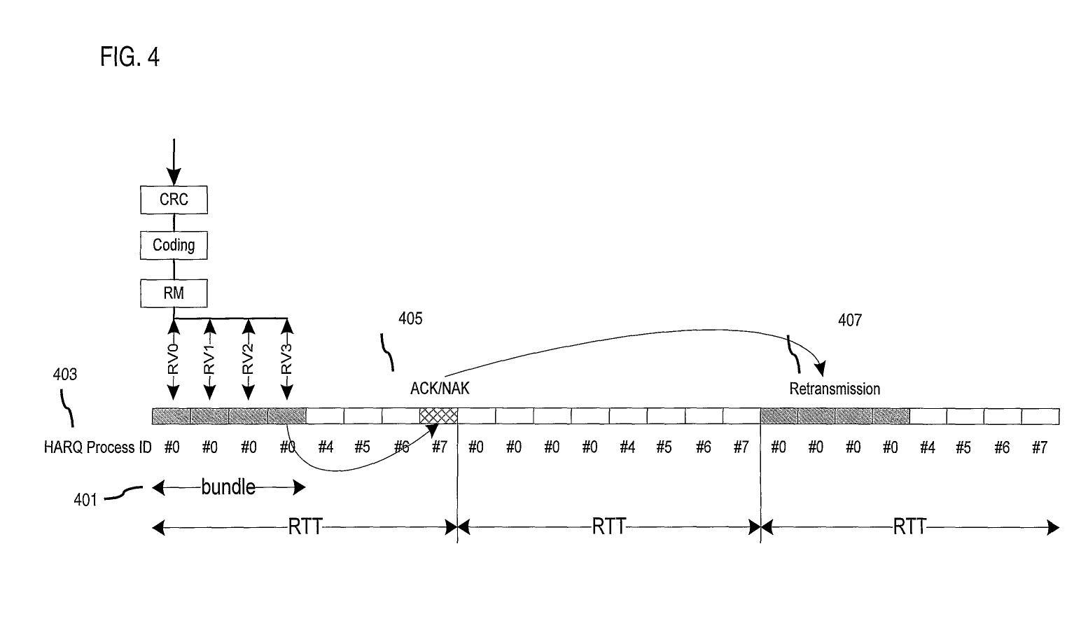

Moreover, in one embodiment, the system 100 utilizes transmission time interval (TTI) bundling. TTI bundling allows repeating the same data in multiple TTIs. The TTI bundling effectively increases the TTI length, thereby allowing the UE 101 to transmit for a longer time. A single transport block is coded and transmitted in a set of consecutive TTIs. The same HARQ process number is used in each of the bundled TTIs. The bundled TTIs are treated as a single resource where only single grant and a single acknowledgement are required. In terms of HARQ acknowledgement and retransmission timing, one TTI bundling method is adopted to LTE specifications, which is illustrated in the FIG. 4.

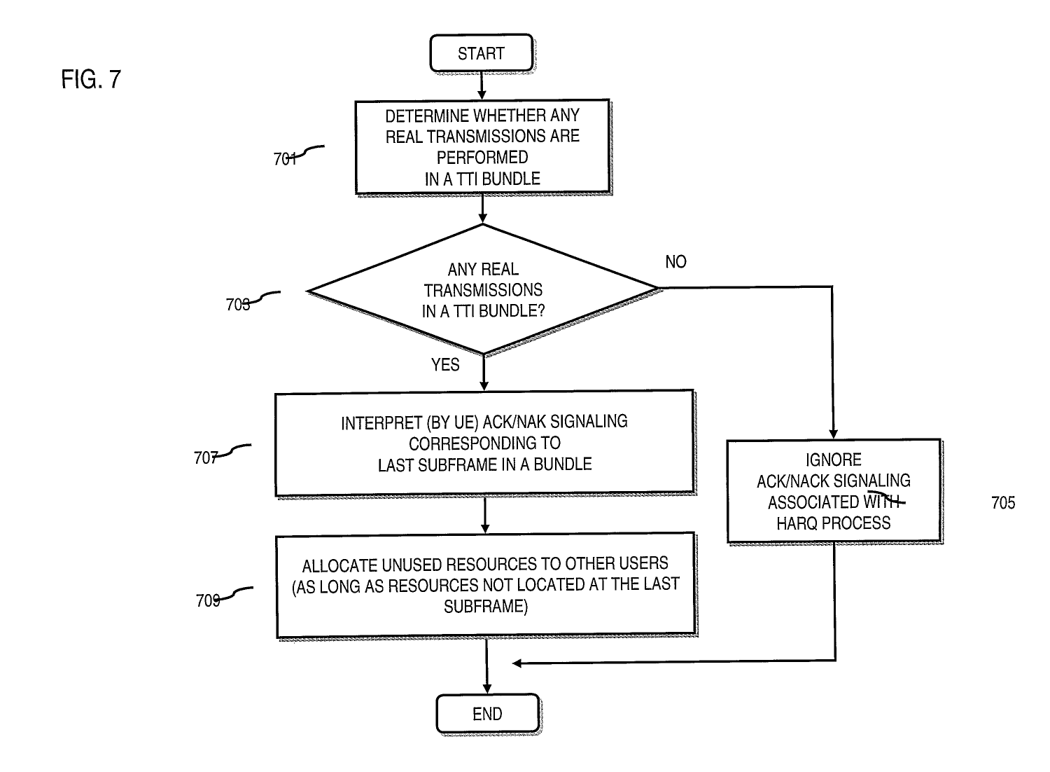

Additionally, the UE 101 and/or the eNB 103 employ respective measurement modules 121a and 121b for performing, for example, inter-frequency or inter-RAT (radio access technology) measurements. These measurements are utilized to adapt to, for example, environmental changes that can negatively affect network performance. Measurement gaps can occur at times that are coordinated between the eNB 103 and UE 101 (through, for example, the measurement modules 121a and 121b). The purpose of the measurement gaps can be, for instance, to enable the UE 101 to perform measurements needed in order to create a measurement report based on network signaling conditions. During a measurement gap, the UE 101 typically cannot receive or transmit, thereby introducing potential “holes” into communication resources. Under certain circumstances, a measurement gap may overlap with TTI bundling, which traditionally cause some performance reduction for LTE TDD because of the communication “holes.” This issue is more fully described with respect to FIGS. 7-9.

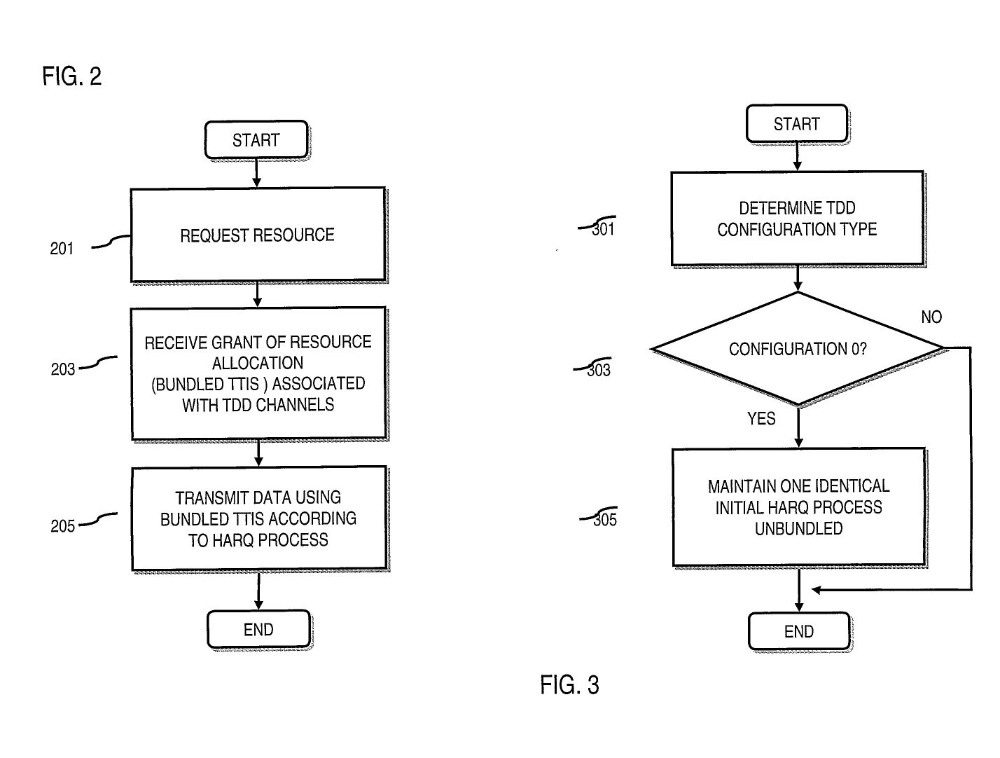

FIG. 2 is a flowchart of a process for transmitting information using bundled transmission time intervals (TTIs), according to an exemplary embodiment. In this example, the UE 101 initiates a request to the network (e.g., BS 103) for resources on the uplink (step 201). In certain embodiments employing LTE, the eNB 103 maintains tight control of the transmission resources. That is, the eNB 103 will, in a controlled manner, grant resources for both uplink and downlink transmissions. Typically, these grants are given on (1) a time-by-time basis (one grant per transmission), or (2) as semi-persistent allocations/grants, where the resources are given for a longer time period. Without a specific allocation of resources from the eNB 103, the UE 101 will not be able to transmit data on the uplink. In response to the request, the BS 103 grants a certain allocation of resources, which are in the form of bundled TTIs associated with, for instance, TDD channels (step 203). In one embodiment, the resource grant may be signalled, for example, implicitly on a physical HARQ indication channel (PHICH) or explicitly on a physical downlink control channel (e.g., a PDCCH). It is contemplated that the eNB 103 may signal the resource allocation on any suitable control channel. After the grant, the UE 101 can proceed to transmit data over the uplink using TTI bundling, along with HARQ to ensure delivery of the information (step 205).

A potential problem with TTI bundling relates to resource collision between unbundled users and bundled users.

FIG. 3 is a flowchart of a process for providing TTI bundling as to avoid resource collisions, according to an exemplary embodiment. One approach is to maintain the same initial hybrid automatic repeat request (HARQ) process unbundled for time division duplex (TDD) configuration 0. Configuration 0 is one of seven radio transmission frame configurations specified in TDD (see Section 5, “Physical Layer for E-UTRA,” of the “3rd Generation Partnership Project; Technical Specification Group Radio Access Network; Evolved Universal Terrestrial Radio Access (E-UTRA) and Evolved Universal Terrestrial Radio Access Network (E-UTRAN); Overall Description; Stage 2 (Release 9),” 3GPP TS. 36.300 V. 9.0.0, June 2009, incorporated herein by reference in its entirety).

Configuration 0 specifies one downlink subframe, one special (S) subframe (including UL control, DL data and control), and three uplink subframes in 5 ms period. The number of HARQ processes for configuration 0 is seven. Table 1 below lists details of this configuration, as well as other TDD configurations.

TABLE 1

| Configuration | | Number of HARQ |
|---|---|---|
| Index | Configuration | Processes |
| 0 | 1DL:1S:3UP | 7 |
| 1 | 2DL:1S:2UL | 4 |
| 2 | 3DL:1S:1 UL | 2 |
| 3 | 6DL:1S:3UL | 3 |
| 4 | 7DL:1S:2UL | 2 |
| 5 | 8DL:1S:1UL | 1 |
| 6 | 2DL:1S:2UL:1DL:1S:3UL | 6 |

Although the approach in the example of FIG. 3 is described with respect to configuration 0, it is contemplated that the approach may be applied to any of the configurations particularly configurations with a greater number of UL time slots (e.g., configuration 1 or configuration 6) or configurations for which TDD specifies use of TTI bundling (e.g., configuration 0, configuration 1, and configuration 6).

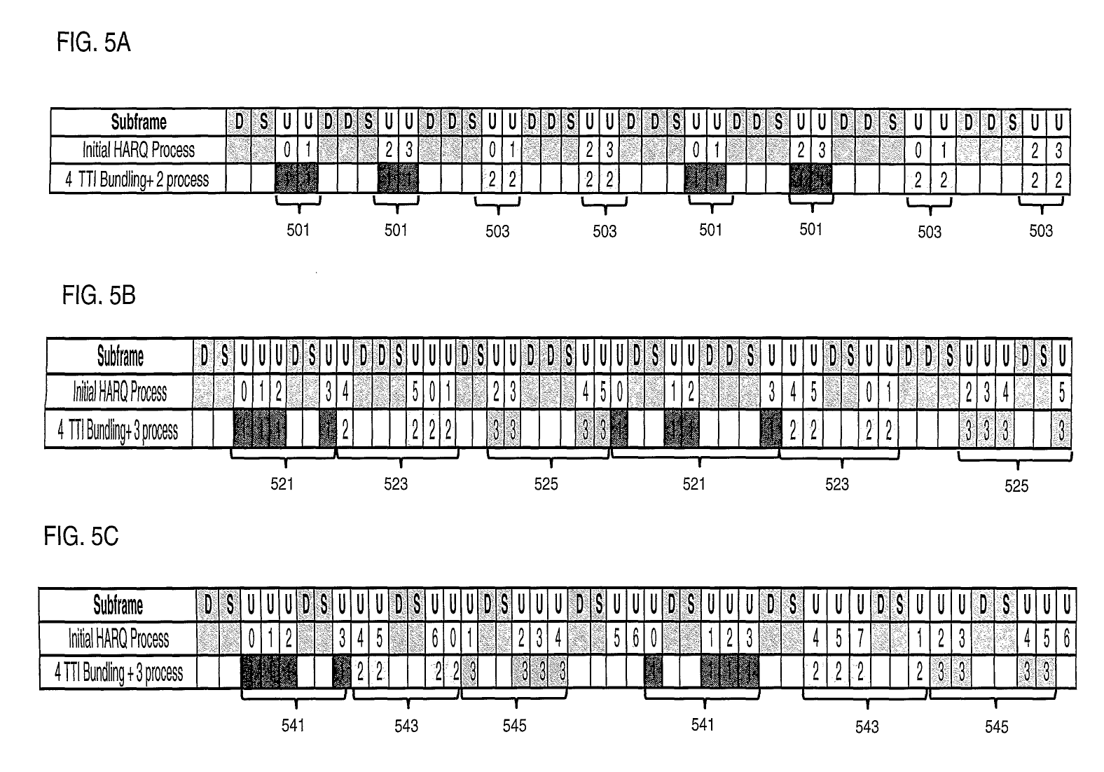

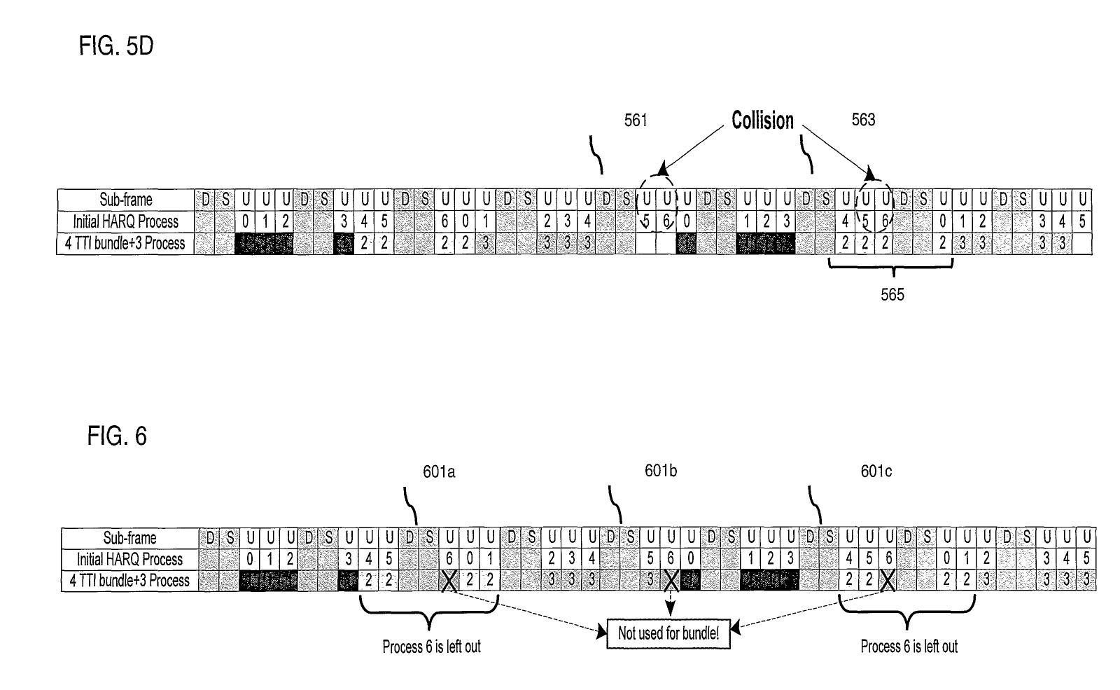

In step 301, the eNB 103 determines the TDD configuration type (e.g., configuration 0 to 6). If the configuration type is configuration 0 (e.g., a configuration type is a relatively high proportion of UL time slots) (step 303), the eNB maintains an identical (or same) initial HARQ process as unbundled (step 305). The process of maintaining the same initial HARQ process as unbundled is described in more detail with respect to FIG. 5.

FIG. 4 is a diagram of an exemplary transmission process for a frequency division duplex (FDD) scheme involving TTI bundling combined with a hybrid automatic repeat request (HARQ) mechanism, according to an exemplary embodiment. According to one embodiment, four (4) sub-frames constitute one bundle 401 for both an FDD and TDD system. Within a bundle 401, operation of the radio includes autonomous retransmission by the UE 101 in consecutive HARQ processes 403 without waiting for ACK/NACK feedback 405 from the eNB 103. The redundancy version (e.g., RV0 to RV3) on each autonomous retransmission in consecutive sub-frames changes in a pre-determined manner.

HARQ acknowledgement 405 is generated after receiving the last subframe in the bundle 401. The timing relation between the last subframe in the bundle 401 and the transmission instant of the HARQ acknowledgement 405 is identical to the case of no bundling. If the last subframe in the bundle 401 is subframe N then the acknowledgement is transmitted in subframe N+4. If the first subframe in the bundle 401 is subframe k then any HARQ retransmissions 407 begins in subframe k+2*HARQ RTT (Round Trip Time). For LTE TDD, TTI bundling is used for LTE TDD configuration 0, configuration 1 and configuration 6 to improve UL coverage.

FIGS. 5A-5D are diagrams of exemplary time division duplex (TDD) configurations implementing a HARQ process, according to various embodiments. It is noted that permanent TTI bundling has good performance due to less resource collisions for FDD.

However, for TDD, permanent TTI bundling can encounter the need to avoid collision of resources. In FIGS. 5A-5D, “initial HARQ process” signifies an HARQ process for normal users (unbundled users); by way of example, the number of these initial HARQ processes is 4, 6, and 7 for TDD configuration 1, configuration 6 and configuration 0, respectively. In these examples, 4 TTI bundles are assumed; thus, this involves 2, 3, and 3 bundled HARQ processes for TDD configuration 1, configuration 6 and configuration 0, respectively.

In the case of FIG. 5A (i.e., TDD configuration 1), there are 4 TTI bundles and 2 bundled HARQ process (e.g., bundled HARQ processes 501 and 503). For TDD configuration 6 (as shown in FIG. 5B), 4 TTI bundle and 3 bundled HARQ process (e.g., bundled HARQ processes 521-525) can be utilized. FIG. 5C shows a TDD configuration 0, involving 4 TTI bundle and 3 bundled HARQ process (e.g., bundled HARQ processes 541-545). In TDD configuration 0, because there are 7 initial HARQ processes to start with, there are 2 TTIs left in which uplink bundled transmissions cannot be carried out with a 4 TTI bundle. One approach for the bundled HARQ processes is that process 5 and process 6 in TDD configuration 0 are not used for TTI bundling users and only used for unbundled users. By way of example, if one frequency resource (e.g., either initial HARQ process 5 or 6) is used for unbundled users, any retransmission that occur as part of error decoding can occur at the following initial HARQ process (e.g., the following HARQ process 5 or 6). In such a case, there may be frequency resource collisions among unbundled users and the bundled users in the corresponding bundled HARQ process (e.g., the bundled HARQ process including the initial HARQ process 5 or 6 such as bundled HARQ process 543 of FIG. 5C).

A possible collision scenario is depicted in FIG. 5D. As shown, a frequency resource 561 including either initial HARQ process 5 or 6 is used by an unbundled user. Because of error decoding, the transmission using the frequency resource 561 requires retransmission at the following initial HARQ process 563 (e.g., the following initial HARQ process 5 or 6). However, this retransmission by the unbundled user creates a potential resource conflict with a bundled user transmitting using the bundled HARQ process 565 over the same frequency resource 563. To address this potential conflict, a new bundled HARQ process design for TDD configuration 0 is provided herein.

FIG. 6 is a diagram of a transmission process that avoids resource collisions using TTI bundling combined with a HARQ mechanism for a TDD configuration 0, according to an exemplary embodiment. To avoid resource collision among unbundled users and bundled users, the same initial HARQ process is left unbundled in continuous HARQ RTT, e.g., initial HARQ process 6 at frequency resources 601a-601c. In other words, at least one of the seven initial HARQ processes of configuration 0 will be left unbundled so that the unbundled initial HARQ process is available only to unbundled users. The remaining initial HARQ processes (e.g., initial HARQ processes 0-5) can be used to form three bundled HARQ process for TDD configuration 0. Accordingly, within a TTI bundle, if an initial HARQ process ID is equal to “unused HARQ process ID” (i.e., initial HARQ process 6 maintained for unbundled users), then the UE 101 does not automatically retransmit in this unused initial HARQ process 6. Because the same HARQ process is always unbundled in each RTT, time-frequency resources not being used by the bundled user can be readily reused by other users. This scenario is advantageously collision-free for that unbundled HARQ process. Consequently, HARQ performance is improved.

By using this design, resource collision among unbundled users and bundled users can be alleviated, while improving spectrum efficiency.

FIG. 7 is a flowchart of a process for handling an overlap condition between a measurement gap and a TTI bundle, according to an exemplary embodiment. In a 3GPP system, the UE 101 is configured with a measurement gap pattern (e.g., 6 ms) when inter-frequency or inter-RAT measurements need to be performed (e.g., when serving cell quality drops below a configured threshold). When an overlap between the measurement gap and UL transmission takes place, UL transmission is not permitted.

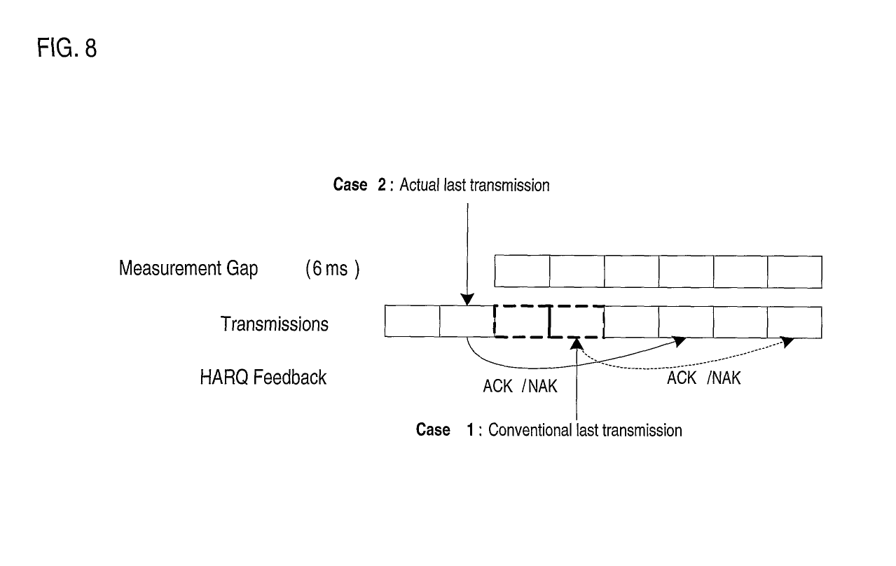

In the process of FIG. 7, a determination is made whether any real transmissions are involved in a TTI bundle (step 701). For example, a real transmission is a transmission of payload data as opposed to dummy data. If no real transmissions are carried out in a bundle (step 703), the UE 101 need not interpret, for instance, all the corresponding ACK/NACK signaling associated with the HARQ process (step 705). However, if any real transmissions are carried out in a bundle (step 703), the UE 101 interprets the ACK/NACK signaling, which may correspond to a last subframe in the TTI bundle (step 707). As a result, unused resources can be allocated to other users (assuming such resources are not located at the last sub-frame in a bundle) (step 709). To better appreciate this potentially problematic condition associated with overlap of the measurement gap and TTI bundling, FIG. 8 is explained in the context of FDD.

FIG. 8 is a diagram of a scenario involving an interaction between a measurement gap and TTI bundling, according to an exemplary embodiment. As seen, the HARQ feedback timing falls into two cases: Case 1, ACK/NACK is taking place at normal location (in terms of the last sub-frame in a bundle); and Case 2, ACK/NACK is taking place at the location corresponding to the latest actual transmissions. The following observations are noted: 1) the same performance for the “actual last transmission” or the “conventional last transmission (which may not have taken place)” should be achieved (for FDD, either definition satisfies this); and 2) to allocate unused resources to other users and make ACK/NACK related to some other user, the general principle should be that when a UL PRB is not used by a UE 101 (e.g. due to measurement gap), then the UE 101 should also not interpret the corresponding DL ACK/NACK signaling.

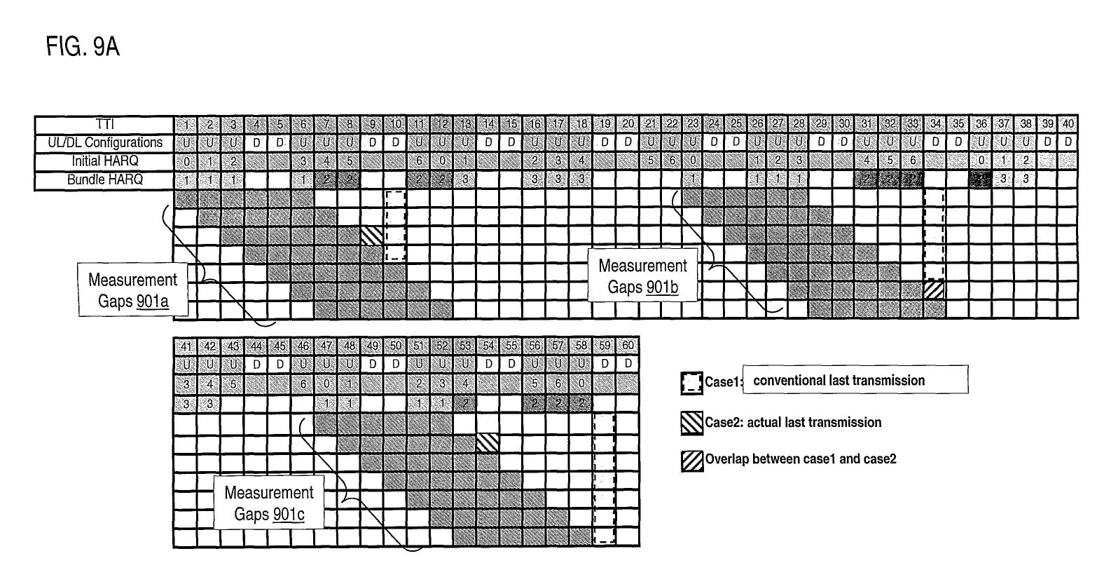

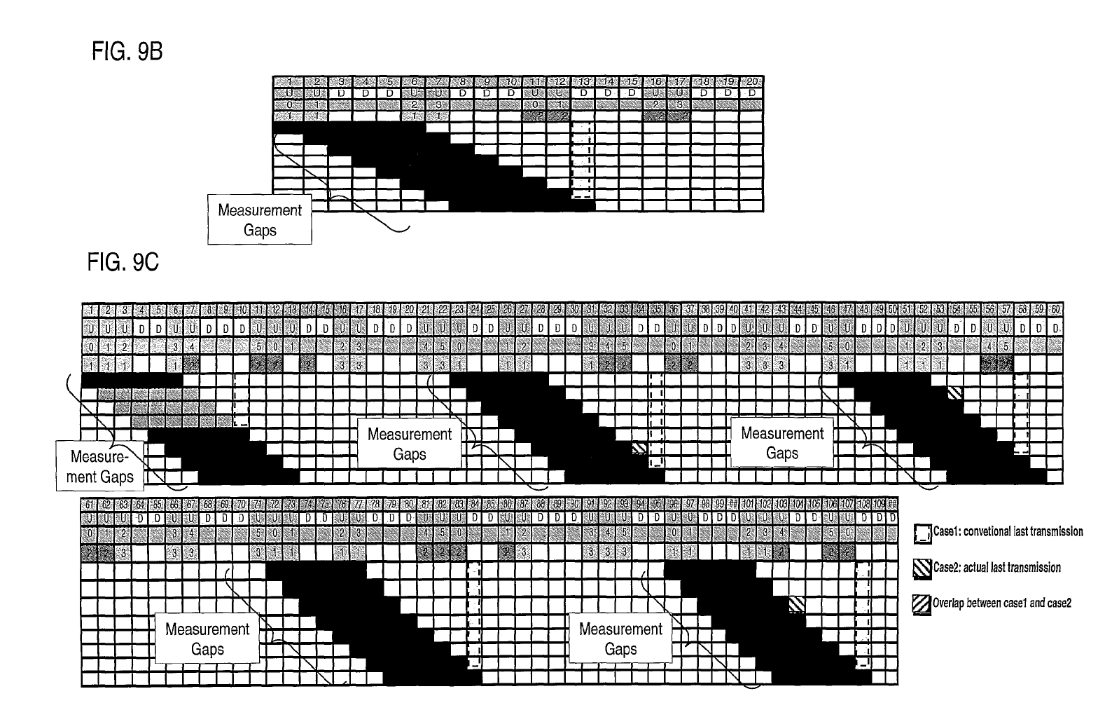

FIGS. 9A-9C are diagrams of exemplary TDD configurations involving the interaction between a measurement gap and TTI bundling, according to various exemplary embodiments. There are 3, 1, and 5 different scenarios for TDD configuration 0, configuration 1, and configuration 6, respectively, in terms of different bundled HARQ positions (refer to FIGS. 9A-9C, correspondingly). Overall, Case 1 (conventional last transmission) can be more efficient than Case 2 (actual last transmission) in terms of the received number of ACK/NACK messages for TDD.

As an example of the first situation of TDD configuration 0 (as shown in FIG. 9A): measurement gaps are depicted in dark gray as labeled; Case 1 ACK/NACK in response to the first bundled transmission is depicted in with dashed lines; Case 2 ACK/NACK in response to the first bundled transmission is depicted in backward hashed marks. In the case of an overlap of Case 1 and Case 2, a forward hashed pattern is used to designate this scenario. When the last two sub-frames in bundled HARQ process 1 are covered by a measurement gap, the location of the ACK/NACK corresponding to the conventional last subframe in a bundle is in subframe 10; and the location of ACK/NACK corresponding to the actual last subframe in a bundle is in subframe 9. Consequently, both locations (e.g., subframes 9 and 10) are not covered by the gap. However, for the other cases, the ACK/NACK that corresponds to the actual last subframe is all covered by the measurement gap and cannot be received (note that ACK/NACK positions are not shown in the figure in the case when a collision occurs with a measurement gap). As a result, Case 1 is better than Case 2 in terms of ACK/NACK that can be received without interference from the measurement gap.

However, if Case 1 is selected for use, one issue is that any UL PRBs covered by measurement gap cannot be allocated to another user, which may decrease the resource efficiency.

The approach described herein addresses the above drawbacks. In one embodiment, if there are no any real transmissions within a bundle due to measurement gap, the UE 101 does not interpret the corresponding DL ACK/NACK signaling. Consequently, the eNB 103 resource allocation module 117 (or scheduler) can allocate the PRB to another user freely, and the corresponding ACK/NACK will also be related to that other user.

In another embodiment, the eNB 103 will always send ACK/NACK based on the last sub-frame in the TTI bundle, and the UE 101 will always interpret the ACK/NACK corresponding to the last sub-frame in a bundle as long as there is one or more real transmissions within the bundle—even when there is no real transmission at last sub-frame. In other words, when a UL PRB is not used by the UE 101 (e.g., due to measurement gap), and the UL PRB is not located at the last subframe in the TTI bundle, the UE 101 need not interpret the corresponding DL ACK/NACK signaling.

The above approach, in certain embodiments, provides a good trade-off between ACK/NACK interpretation and resource efficiency. Namely, the UE 101 can obtain a true ACK/NACK interpretation for most TDD cases, while being able to allocate most of the unused resources to other users.

FIGS. 10A-10D are diagrams of communication systems having exemplary long-term evolution (LTE) architectures, in which the user equipment (UE) 101 and the base station 103 of FIG. 1 can operate, according to various exemplary embodiments of the invention.

By way of example (shown in FIG. 10A), a base station 103 (e.g., destination node) and a user equipment (UE) 101 (e.g., source node) can communicate in system 1000 using any access scheme, such as Time Division Multiple Access (TDMA), Code Division Multiple Access (CDMA), Wideband Code Division Multiple Access (WCDMA), Orthogonal Frequency Division Multiple Access (OFDMA) or Single Carrier Frequency Division Multiple Access (FDMA) (SC-FDMA) or a combination of thereof. In an exemplary embodiment, both uplink and downlink can utilize WCDMA. In another exemplary embodiment, uplink utilizes SC-1-DMA, while downlink utilizes OFDMA. The communication system 1000 is compliant with 3GPP LTE, entitled “Long Term Evolution of the 3GPP Radio Technology” (which is incorporated herein by reference in its entirety). As shown in FIG. 10A, one or more user equipment (UEs) 101 communicate with a network equipment, such as a base station 103, which is part of an access network (e.g., WiMAX (Worldwide Interoperability for Microwave Access), 3GPP LTE (or E-UTRAN), etc.). Under the 3GPP LTE architecture, base station 103 is denoted as an enhanced Node B (eNB).

MME (Mobile Management Entity)/Serving Gateways 1001 are connected to the eNBs 103 in a full or partial mesh configuration using tunneling over a packet transport network (e.g., Internet Protocol (IP) network) 1003. Exemplary functions of the MME/Serving GW 1001 include distribution of paging messages to the eNBs 103, termination of U-plane packets for paging reasons, and switching of U-plane for support of UE mobility. Since the GWs 1001 serve as a gateway to external networks, e.g., the Internet or private networks 1003, the GWs 1001 include an Access, Authorization and Accounting system (AAA) 1005 to securely determine the identity and privileges of a user and to track each user's activities. Namely, the MME Serving Gateway 1001 is the key control-node for the LTE access-network and is responsible for idle mode UE tracking and paging procedure including retransmissions. Also, the MME 1001 is involved in the bearer activation/deactivation process and is responsible for selecting the SGW (Serving Gateway) for a UE at the initial attach and at time of intra-LTE handover involving Core Network (CN) node relocation.

A more detailed description of the LTE interface is provided in 3GPP TR 25.813, entitled “E-UTRA and E-UTRAN: Radio Interface Protocol Aspects,” which is incorporated herein by reference in its entirety.

In FIG. 10B, a communication system 1002 supports GERAN (GSM/EDGE radio access) 1004, and UTRAN 1006 based access networks, E-UTRAN 1012 and non-3GPP (not shown) based access networks, and is more fully described in TR 23.882, which is incorporated herein by reference in its entirety. A key feature of this system is the separation of the network entity that performs control-plane functionality (MME 1008) from the network entity that performs bearer-plane functionality (Serving Gateway 1010) with a well defined open interface between them S11. Since E-UTRAN 1012 provides higher bandwidths to enable new services as well as to improve existing ones, separation of MME 1008 from Serving Gateway 1010 implies that Serving Gateway 1010 can be based on a platform optimized for signaling transactions. This scheme enables selection of more cost-effective platforms for, as well as independent scaling of, each of these two elements. Service providers can also select optimized topological locations of Serving Gateways 1010 within the network independent of the locations of MMEs 1008 in order to reduce optimized bandwidth latencies and avoid concentrated points of failure.

As seen in FIG. 10B, the E-UTRAN (e.g., eNB) 1012 interfaces with UE 101 via LTE-Uu. The E-UTRAN 1012 supports LTE air interface and includes functions for radio resource control (RRC) functionality corresponding to the control plane MME 1008. The E-UTRAN 1012 also performs a variety of functions including radio resource management, admission control, scheduling, enforcement of negotiated uplink (UL) QoS (Quality of Service), cell information broadcast, ciphering/deciphering of user, compression/decompression of downlink and uplink user plane packet headers and Packet Data Convergence Protocol (PDCP).

The MME 1008, as a key control node, is responsible for managing mobility UE identifies and security parameters and paging procedure including retransmissions. The MME 1008 is involved in the bearer activation/deactivation process and is also responsible for choosing Serving Gateway 1010 for the UE 101. MME 1008 functions include Non Access Stratum (NAS) signaling and related security. MME 1008 checks the authorization of the UE 101 to camp on the service provider's Public Land Mobile Network (PLMN) and enforces UE 101 roaming restrictions. The MME 1008 also provides the control plane function for mobility between LTE and 2G/3G access networks with the S3 interface terminating at the MME 1008 from the SGSN (Serving GPRS Support Node) 1014.

The SGSN 1014 is responsible for the delivery of data packets from and to the mobile stations within its geographical service area. For example, SGSN 1014 performs tasks that include packet routing and transfer, mobility management, logical link management, and authentication and charging functions. The S6a interface enables transfer of subscription and authentication data for authenticating/authorizing user access to the evolved system (AAA interface) between MME 1008 and HSS (Home Subscriber Server) 1016. The S10 interface between MMEs 1008 provides MME relocation and MME 1008 to MME 1008 information transfer. The Serving Gateway 1010 is the node that terminates the interface towards the E-UTRAN 1012 via S1-U.

The S1-U interface provides a per bearer user plane tunneling between the E-UTRAN 1012 and Serving Gateway 1010. This interface contains support for path switching during handover between eNBs 103. The S4 interface provides the user plane with related control and mobility support between SGSN 1014 and the 3GPP Anchor function of Serving Gateway 1010.

The S12 is an interface between UTRAN 1006 and Serving Gateway 1010. Packet Data Network (PDN) Gateway 1018 provides connectivity to the UE 101 to external packet data networks by being the point of exit and entry of traffic for the UE 101. The PDN Gateway 1018 performs policy enforcement, packet filtering for each user, charging support, lawful interception and packet screening. Another role of the PDN Gateway 1018 is to act as the anchor for mobility between 3GPP and non-3GPP technologies such as WiMax and 3GPP2 (CDMA 1X and EvDO (Evolution Data Only)).

The S7 interface provides transfer of QoS policy and charging rules from PCRF (Policy and Charging Role Function) 1020 to Policy and Charging Enforcement Function (PCEF) in the PDN Gateway 1018. The SGi interface is the interface between the PDN Gateway and the operator's IP services including packet data network 1022. Packet data network 1022 may be an operator external public or private packet data network or an intra operator packet data network, e.g., for provision of IMS (IP Multimedia Subsystem) services. Rx+ is the interface between the PCRF and the packet data network 1022.

As seen in FIG. 10C, the eNB 103 utilizes an E-UTRA (Evolved Universal Terrestrial Radio Access) (user plane, e.g., RLC (Radio Link Control) 1015, MAC (Media Access Control) 1017, and PHY (Physical) 1019, as well as a control plane (e.g., RRC 1021)).

The eNB 103 also includes the following functions: Inter Cell RRM (Radio Resource Management) 1023, Connection Mobility Control 1025, RB (Radio Bearer) Control 1027, Radio Admission Control 1029, eNB Measurement Configuration and Provision 1031, and Dynamic Resource Allocation (Scheduler) 1033.

The eNB 103 communicates with the aGW 1001 (Access Gateway) via an S1 interface. The aGW 1001 includes a User Plane 1001a and a Control plane 1001b. The control plane 1001b provides the following components: SAE (System Architecture Evolution) Bearer Control 1035 and MM (Mobile Management) Entity 1037. The user plane 1001b includes a PDCP (Packet Data Convergence Protocol) 1039 and a user plane functions 1041. It is noted that the functionality of the aGW 1001 can also be provided by a combination of a serving gateway (SGW) and a packet data network (PDN) GW. The aGW 1001 can also interface with a packet network, such as the Internet 1043.

In an alternative embodiment, as shown in FIG. 10D, the PDCP (Packet Data Convergence Protocol) functionality can reside in the eNB 103 rather than the GW 1001. Other than this PDCP capability, the eNB functions of FIG. 10C are also provided in this architecture.

In the system of FIG. 10D, a functional split between E-UTRAN and EPC (Evolved Packet Core) is provided. In this example, radio protocol architecture of E-UTRAN is provided for the user plane and the control plane. A more detailed description of the architecture is provided in 3GPP TS 86.300.

The eNB 103 interfaces via the S1 to the Serving Gateway 1045, which includes a Mobility Anchoring function 1047. According to this architecture, the MME (Mobility Management Entity) 1049 provides SAE (System Architecture Evolution) Bearer Control 1051, Idle State Mobility Handling 1053, and NAS (Non-Access Stratum) Security 1055.

One of ordinary skill in the art would recognize that the processes for acknowledgement bundling may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

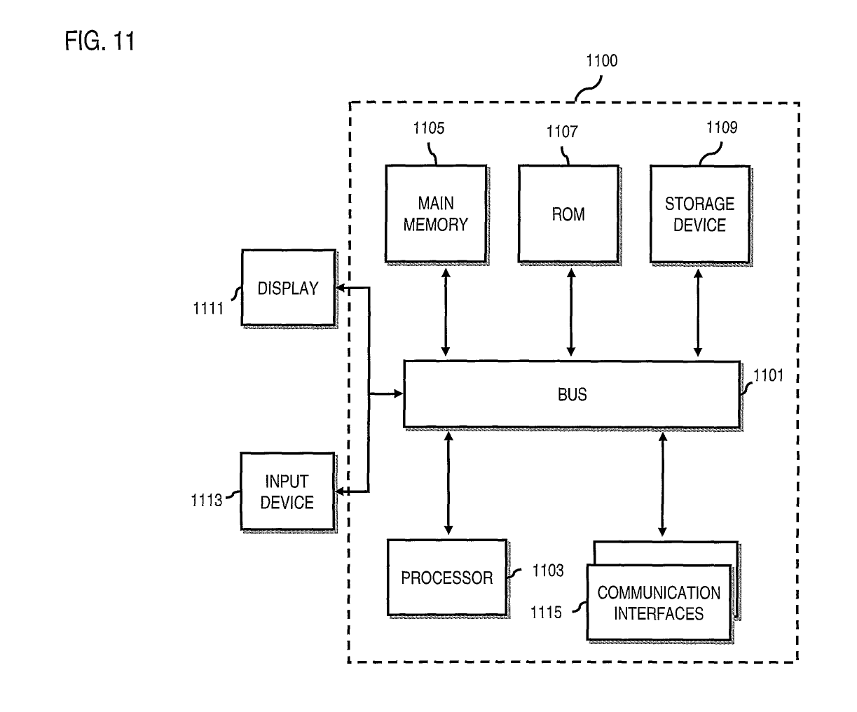

FIG. 11 illustrates exemplary hardware upon which various embodiments of the invention can be implemented. A computing system 1100 includes a bus 1101 or other communication mechanism for communicating information and a processor 1103 coupled to the bus 1101 for processing information. The computing system 1100 also includes main memory 1105, such as a random access memory (RAM) or other dynamic storage device, coupled to the bus 1101 for storing information and instructions to be executed by the processor 1103. Main memory 1105 can also be used for storing temporary variables or other intermediate information during execution of instructions by the processor 1103. The computing system 1100 may further include a read only memory (ROM) 1107 or other static storage device coupled to the bus 1101 for storing static information and instructions for the processor 1103. A storage device 1109, such as a magnetic disk or optical disk, is coupled to the bus 1101 for persistently storing information and instructions.

The computing system 1100 may be coupled via the bus 1101 to a display 1111, such as a liquid crystal display, or active matrix display, for displaying information to a user. An input device 1113, such as a keyboard including alphanumeric and other keys, may be coupled to the bus 1101 for communicating information and command selections to the processor 1103. The input device 1113 can include a cursor control, such as a mouse, a trackball, or cursor direction keys, for communicating direction information and command selections to the processor 1103 and for controlling cursor movement on the display 1111.

According to various embodiments of the invention, the processes described herein can be provided by the computing system 1100 in response to the processor 1103 executing an arrangement of instructions contained in main memory 1105. Such instructions can be read into main memory 1105 from another computer-readable medium, such as the storage device 1109. Execution of the arrangement of instructions contained in main memory 1105 causes the processor 1103 to perform the process steps described herein. One or more processors in a multi-processing arrangement may also be employed to execute the instructions contained in main memory 1105. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 1100 also includes at least one communication interface 1115 coupled to bus 1101. The communication interface 1115 provides a two-way data communication coupling to a network link (not shown). The communication interface 1115 sends and receives electrical, electromagnetic, or optical signals that carry digital data streams representing various types of information. Further, the communication interface 1115 can include peripheral interface devices, such as a Universal Serial Bus (USB) interface, a PCMCIA (Personal Computer Memory Card International Association) interface, etc.

The processor 1103 may execute the transmitted code while being received and/or store the code in the storage device 1109, or other non-volatile storage for later execution. In this manner, the computing system 1100 may obtain application code in the form of a carrier wave.

The term “computer-readable medium” as used herein refers to any medium that participates in providing instructions to the processor 1103 for execution. Such a medium may take many forms, including but not limited to non-volatile media, volatile media, and transmission media. Non-volatile media include, for example, optical or magnetic disks, such as the storage device 1109. Volatile media include dynamic memory, such as main memory 1105. Transmission media include coaxial cables, copper wire and fiber optics, including the wires that comprise the bus 1101. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

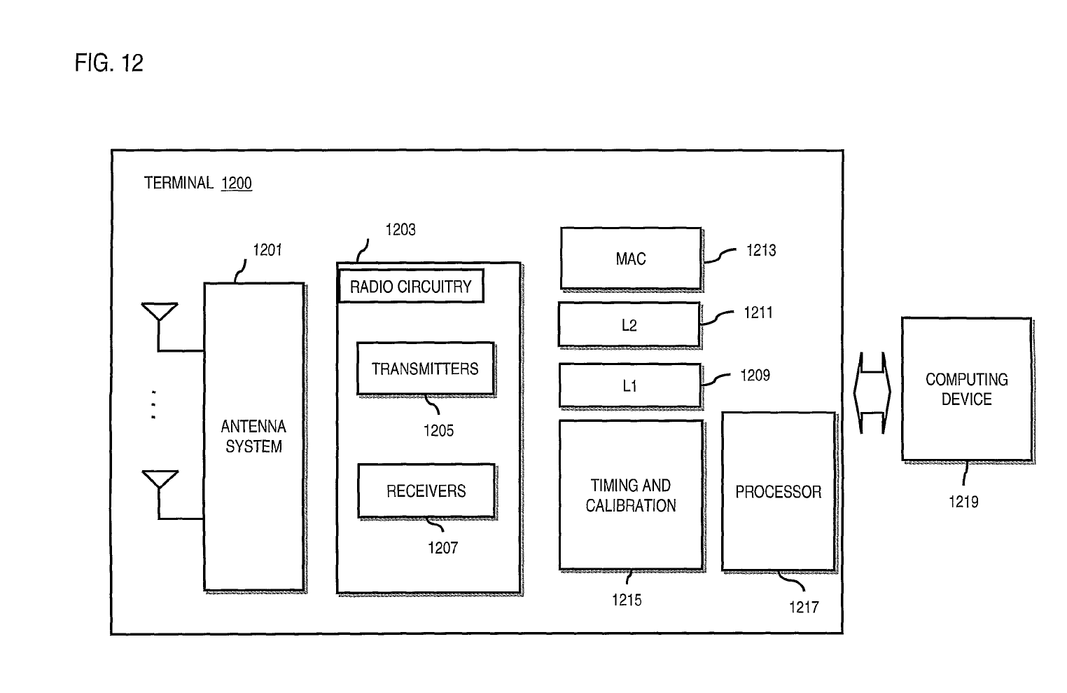

FIG. 12 is a diagram of exemplary components of a user terminal configured to operate in the systems of FIGS. 10A-10D, according to an embodiment of the invention. A user terminal 1200 includes an antenna system 1201 (which can utilize multiple antennas) to receive and transmit signals. The antenna system 1201 is coupled to radio circuitry 1203, which includes multiple transmitters 1205 and receivers 1207. The radio circuitry encompasses all of the Radio Frequency (RF) circuitry as well as base-band processing circuitry. As shown, layer-1 (L1) and layer-2 (L2) processing are provided by units 1209 and 1211, respectively. Optionally, layer-3 functions can be provided (not shown). Module 1213 executes all Medium Access Control (MAC) layer functions. A timing and calibration module 1215 maintains proper timing by interfacing, for example, an external timing reference (not shown). Additionally, a processor 1217 is included. Under this scenario, the user terminal 1200 communicates with a computing device 1219, which can be a personal computer, work station, a Personal Digital Assistant (PDA), web appliance, cellular phone, etc.

While the invention has been described in connection with a number of embodiments and implementations, the invention is not so limited but covers various obvious modifications and equivalent arrangements, which fall within the purview of the claims. Although features of the invention are expressed in certain combinations among the claims, it is contemplated that these features can be arranged in any combination and order.

1-30. (canceled)

31. A method comprising:
allocating a plurality of transmission time intervals (TTIs) of a time duplex division (TDD) transmission scheme as a bundle for supporting transmission of duplicate data over the TTIs, wherein the bundle of TTIs is associated with a plurality of initial hybrid automatic repeat request (HARQ) processes; and
maintaining one or more of the same initial HARQ processes as unbundled for a predetermined TDD configuration.

32. A method according to claim 31, wherein the TDD configuration includes a configuration 0 format.

33. An apparatus comprising:
a logic configured to allocate a plurality of transmission time intervals (TTIs) of a time duplex division (TDD) transmission scheme as a bundle for supporting transmission of duplicate data over the TTIs, wherein the bundle of TTIs is associated with a plurality of initial hybrid automatic repeat request (HARQ) processes; and to maintain one or more of the same initial HARQ processes as unbundled for a predetermined TDD configuration.

34. An apparatus according to claim 33, wherein the TDD configuration includes a configuration 0 format.

35. An apparatus according to claim 33, wherein the bundle includes four TTIs.

36. An apparatus according to claim 33, wherein the apparatus is a handset.

37. A method comprising:
determining whether any real transmissions are utilized in a plurality of transmission time intervals (TTIs) of a time duplex division (TDD) transmission scheme, wherein the plurality of TTIs is allocated as a bundle and the bundle of TTIs overlap with a measurement gap period;
interpreting an acknowledgement signal corresponding to a last subframe of the bundle of TTIs if there are any real transmissions utilized in the bundle of TTIs.

38. A method according to claim 37, further comprising:
ignoring the acknowledgement signal if there are no real transmissions utilized in the bundle of TTIs.

39. A method of claim 37, further comprising:
re-allocating unused resources of the bundle of TTIs to other users if the resources are not located in the last subframe of the bundle of TTIs.

40. A method according to claim 37, further comprising:
re-allocating resources of the bundle of TTIs that are covered by the measurement gap period.

41. A method according to claim 37, wherein the TDD transmission scheme utilizes one of a configuration 0 format, a configuration 1 format, or a configuration 6 format.

42. A computer-readable storage medium carrying one or more sequences of one or more instructions which, when executed by one or more processors, cause an apparatus to perform the method of claim 37.

43. An apparatus comprising:
a logic configure to determine whether any real transmissions are utilized in a plurality of transmission time intervals (TTIs) of a time duplex division (TDD) transmission scheme, wherein the plurality of TTIs is allocated as a bundle and the bundle of TTIs overlap with a measurement gap period; to interpret an acknowledgement signal corresponding to a last subframe of the bundle of TTIs if there are any real transmissions utilized in the bundle of TTIs.

44. An apparatus according to claim 43, wherein the logic is further configured to ignore the acknowledgement signal if there are no real transmissions utilized in the bundle of TTIs.

45. An apparatus of claim 43, wherein the logic is further configured to re-allocate unused resources of the bundle of TTIs to other users if the resources are not located in the last subframe of the bundle of TTIs.

46. An apparatus according to claim 43, wherein the logic is further configured to re-allocate resources of the bundle of TTIs that are covered by the measurement gap period.

47. An apparatus according to claim 43, wherein the acknowledgement signal is generated based on a hybrid automatic repeat request (HARD) process.

48. An apparatus according to claim 43, wherein the TDD transmission scheme utilizes one of a configuration 0 format, a configuration 1 format, or a configuration 6 format.

49. An apparatus according to claim 43, wherein the apparatus is a handset.

50. An apparatus comprising:
a logic configure to determine whether any real transmissions are utilized in a plurality of transmission time intervals (TTIs) of a time duplex division (TDD) transmission scheme, wherein the plurality of TTIs is allocated as a bundle and the bundle of TTIs overlap with a measurement gap period; to determine an acknowledgement signal corresponding to a last subframe of the bundle of TTIs if there are any real transmissions utilized in the bundle of TTIs.
